(19) United States
(12) Patent Application Publication
(10) Pub. No.: US 2015/0329686 A1
(43) Pub. Date: Nov. 19, 2015

(54) BIOCOMPOSITE MATERIALS DERIVED FROM ANIMAL PROTEIN

(71) Applicant: THE GOVERNORS OF THE UNIVERSITY OF ALBERTA, Edmonton (CA)

(72) Inventors: David BRESSLER, Edmonton (CA); Phillip CHOI, Edmonton (CA)

(73) Assignee: THE GOVERNORS OF THE UNIVERSITY OF ALBERTA, Edmonton (CA)

(21) Appl. No.: 14/440,156

(22) PCT Filed: Nov. 6, 2013
(86) PCT No.: PCT/CA2013/050847

§ 371 Date: May 1, 2015

Related U.S. Application Data
(60) Provisional application No. 61/723,031, filed on Nov. 6, 2012.

(51) Int. Cl. C08J 5/24; C08K 7/02; C08K 7/14; C08J 3/24; C08J 5/04

(52) U.S. Cl. CPC C08J 5/24; C08J 3/24; C08J 5/043; C08J 5/045; C08K 7/14; C08K 7/02; C08J 2389/04

(57) ABSTRACT

Biocomposite materials are derived from animal proteins, and, in particular, animal proteins derived from byproducts such as specified risk material. The composite materials are created by embedding a fibrous material with a polymer matrix comprising a hydrolysate from the animal protein and a crosslinking reagent such as an epoxy.

### FIELD OF THE INVENTION

The invention relates to biocomposite materials derived from animal proteins, and methods of producing the same.

### BACKGROUND OF THE INVENTION

Transmissible spongiform encephalopathies (TSEs) are progressive, fatal diseases affecting the nervous system, causing spongy degeneration in the brain and spinal cord. TSEs include bovine spongiform encephalopathy (BSE or mad cow disease) in cattle, scrapie in sheep, chronic wasting disease in deer and elk, and variant Creutzfeldt-Jakob disease (vCJD) in humans. Although the exact cause of TSEs is unknown, the infectious agent is suspected to be a prion, a misfolded protein which has the ability to self-replicate and accumulate in neural tissue, eventually causing tissue damage and cell death. There is no treatment or vaccine currently available for the disease. Prions are notoriously resistant to routine methods of decontamination.

BSE was first diagnosed in 1986 in the United Kingdom where the majority of the world's cases have occurred. The first North American cases were discovered in 2003. Consumption by cattle of BSE-contaminated ruminant proteins in animal feed has been cited as the most likely means of transmission. Such outbreaks have had major implications for the North American beef industries since foreign markets have closed their borders to beef and cattle exports. Surveillance programs to monitor and assess BSE in cattle herds have been implemented to provide early detection and contain any possible spread in order to keep BSE out of the food supplies of both animals and humans. In humans, vCJD is thought to be linked to the consumption of meat products derived from BSE-infected cattle.

Prior to the emergence of BSE, the primary use for animal protein by-products was as feed ingredients for cattle, poultry, pets and aquaculture in the form of meat and bone meal, meat meal and blood meal. Subsequently, specific cattle tissues, known as specified risk materials (SRM), have been banned from use in animal feed, pet food and fertilizers, and have been accumulating into landfills at a rate of about 5000 tons per week.

Rendering is a process whereby waste is “cooked” into ingredients for a wide range of industrial and consumer goods. Regulatory actions to strengthen safeguards against BSE portend significant changes in renderer's business practices, and the value of their products. If inedible animal byproducts have fewer market outlets, the overall economic value of the animal to the producer can decline, and questions arise about how to safely dispose of the SRM. The necessary restructuring of the rendering processing lines to handle SRM and non-SRM in separate lines and costs associated with SRM storing, transporting, and disposal fees have adversely affected profitability to operators and negatively impacted the beef industry.

Therefore, there is a need in the art to utilize SRM and other animal waste products, and produce useful products.

### SUMMARY OF THE INVENTION

The present invention relates to composite materials derived from animal proteins, and, in particular, animal proteins derived from byproducts. The composite materials are created by embedding a fibrous material with a polymer comprising an animal protein and a crosslinking reagent such as an epoxy, followed by curing.

In one aspect, the invention comprises a method for preparing a composite material comprising a polymer derived from a feedstock comprising animal proteins, comprising the steps of:
a) hydrolyzing the feedstock and recovering a protein fraction;
b) combining a fibrous material with the protein fraction and a crosslinking reagent to form a prepolymer or a prepreg; and
c) curing the mixture to create a thermoset composite material.
   The fibrous material may comprise a synthetic fiber, such as glass or carbon fibers, or a natural fiber, such as any lignocellulosic material, or an agricultural fiber such as hemp, flax, jute or the like. The fibrous material may be dispersed within the polymer, or the polymer may be applied to a preformed mat of the fibers. The fibers in the mat may be random, oriented, or woven together in some manner.

In one embodiment, the feedstock may comprise a fresh meat carcass, a biological tissue, blood meal, meat, bone meal, or a specified risk material, or combinations thereof. In one embodiment, the animal protein may be obtained from a specified risk material, which may comprise tissues such as brain, skull, eyes, trigeminal ganglia, spinal cord, vertebral column, dorsal root ganglia, tonsils, the distal ileum of the small intestine, or combinations thereof from cattle over 30 months of age, and the distal ileum and tonsils from cattle of all ages as defined by the National Renderers Association (Hamilton, C. R. and D. Kirstein, 2011). In one embodiment, the animal proteins may be at risk of contamination of a pathogen which may comprise a bacteria, virus, fungi, parasite, or prion.

In one embodiment, the hydrolysis step comprises thermal hydrolysis. For example, the animal proteins may be subjected to temperatures of at least about 180° C. and at a pressure of about 1,200 kPa, for a length of time sufficient to produce hydrolyzed proteins of a desired size. For example, hydrolysis at about 180° C. and at about 1,200 kPa for at least 40 minutes, may produce hydrolyzed proteins having an average molecular weight less than about 70 kDa.

In one embodiment, the hydrolysis step comprises alkaline hydrolysis where the proteins are hydrolyzed in the presence of a base. In one embodiment, the base comprises an aqueous solution of an alkali metal hydroxide or an alkaline earth metal hydroxide. In one embodiment, alkaline hydrolysis may take place under elevated temperature and pressure, for a sufficient length of time to produce hydrolyzed proteins of a desired size, and to destroy or mitigate any infectious agents. For example, the alkaline hydrolysis may be conducted at a temperature of about 150° C. and at a pressure of about 400 kPa. In one embodiment, the hydrolyzed proteins produced by alkaline hydrolysis has an average molecular weight of less than 35 kDa.

In one embodiment, the crosslinking reagent comprises glutaraldehyde, glyoxal, resorcinol, benzaldehyde, 1-ethyl-3-(3-dimethylaminopropyl)carbodiimide, N-hydroxysuccinimide, N,N-dicyclohexylcarbodiimide, or an epoxy. In one embodiment, the crosslinking reagent is an epoxy such as a diglycidyl ether of bisphenol A, aliphatic polyglycol epoxy, or resorcinol diglycidyl ether.

In one embodiment, the method further comprises the step of blending the mixture with a natural or synthetic rubber.

Additional aspects and advantages of the present invention will be apparent in view of the description, which follows. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will now be described by way of an exemplary embodiment with reference to the accompanying simplified, diagrammatic, not-to-scale drawings:

FIG. 1 is a schematic diagram showing one embodiment of the method of the present invention.

FIG. 2 is a schematic diagram showing one embodiment of the method of the present invention.

FIG. 3 is a graph showing total free amines as a function of the crosslinking reagent and molar concentration.

FIG. 4 is a Fourier transform infrared spectra of hydrolyzed protein, epoxy resin, and epoxy resin crosslinked polymer.

FIG. 5 is a Fourier transform infrared spectra of hydrolyzed protein prior to crosslinking.

FIG. 6 is a Fourier transform infrared spectra of the hydrolyzed protein of FIG. 5 after crosslinking with resorcinol diglycidyl ether.

### DETAILED DESCRIPTION OF PREFERRED EMBODIMENTS

The present invention relates to polymers and plastics, and methods for preparing same from animal proteins.

When describing the present invention, all terms not defined herein have their common art-recognized meanings. To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as defined in the appended claims.

It is known to use natural fibers as a dispersed phase embedded in synthetic polymer matrixes from non-renewable sources to create light-weight composite materials with high tensile strength. In one aspect of the present invention, the invention comprises a method for preparing a composite material comprising a polymer matrix derived from a feedstock comprising animal proteins and a fibrous material.

The composite material may comprise a pre-impregnated composite material, or “prepreg” as it is commonly known, which is a combination of the polymer and fibrous material, prior to curing into a thermoset plastic. A prepreg may be manufactured and stored in a cool location, if the curing or activation is done by heat.

The fibrous material may comprise a synthetic fiber, such as glass (electrical grade glass or e-glass), carbon or aramid fibers, or a natural fiber, such as any cellulosic or lignocellulosic material including without limitation, wood, or an agricultural fiber such as hemp, flax, jute or the like. The fibrous material may be dispersed within the polymer matrix, or the polymer may be applied to a preformed mat of the fibers. The fibers in the mat may be random, oriented, or woven together in some manner. The final product may comprise multiple layers of fibrous material.

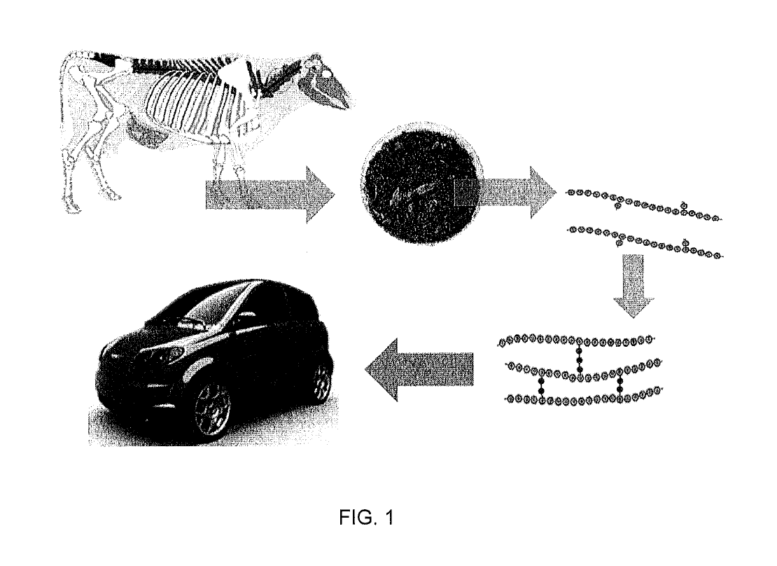

As shown generally in FIG. 1, one embodiment of the method utilizes an agricultural byproduct stream as a source of animal proteins, which are modified to form crosslinked polymers having desirable physical and chemical properties, which are then used to form the composite materials described herein. Conventionally, a thermosetting polymer is a prepolymer in a soft solid or viscous state that changes irreversibly into an infusible, insoluble polymer network by curing. Curing can be induced by the action of heat or suitable radiation, or both.

In one embodiment, the invention comprises a method for preparing a composite material comprising a polymer derived from a feedstock comprising animal proteins, comprising the steps of:

a) hydrolyzing the feedstock and recovering a protein fraction;

b) combining a fibrous material with the protein fraction and a crosslinking reagent.

The combined material may be uncured or partially cured and used as a prepolymer or prepreg material. Upon curing, the mixture becomes a solid, rigid thermoset composite material.

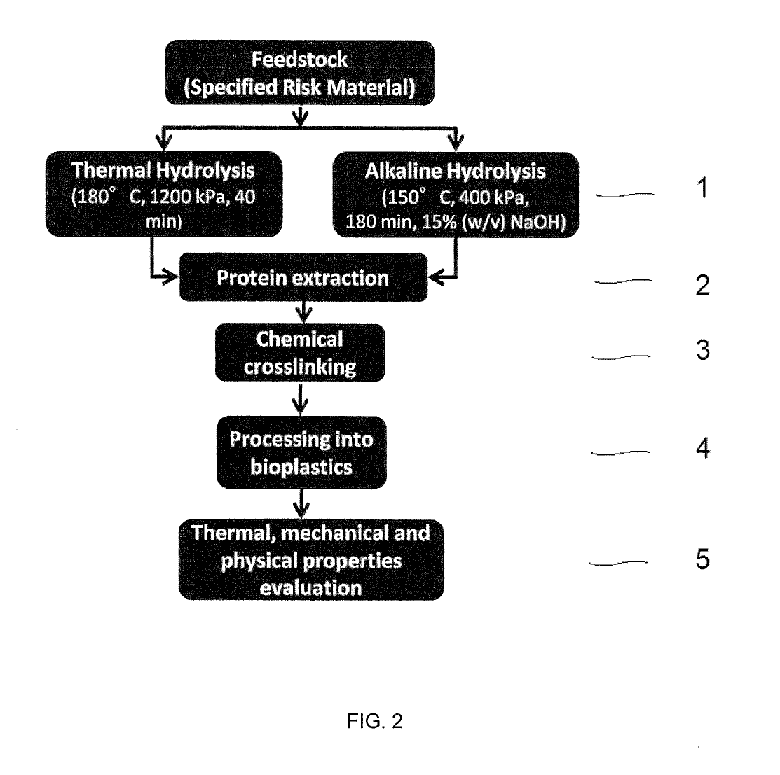

As shown in FIG. 2, the polymers are produced from animal proteins using the methods described herein. The method generally involves at least the following steps: (1) hydrolyzing the proteins in a feedstock using a process such as either thermal hydrolysis or alkaline hydrolysis; (2) extracting a protein fraction from the hydrolyzed feedstock, and (3) combining a fibrous material with the protein fraction and a crosslinking reagent, and (4) curing the mixture to obtain biocomposite thermoset material. The crosslinking reagent may be added to the protein prior to combining with a fibrous material if the if the crosslinking reactions do not proceed very rapidly. The thermal, mechanical and physical properties of the resultant biocomposites may be evaluated to assess their suitability for particular applications.

The detailed steps of the process are as follows. A feedstock containing animal proteins is used as the starting material. As used herein, the term “feedstock” means an animal product which comprises proteins. Feedstock may include fresh or processed meat carcasses or other animal tissues, such as blood meal (i.e., the dried blood left over after carcasses are processed at a rendering plant), meat, bone meal, and specified risk material. The feedstock may be contaminated with, or at risk of contamination with infectious agents which may include, but not limited to, bacteria, viruses, fungi, parasites, and prions. As used herein, the term “prion” means a proteinaceous-infectious agent which causes transmissible spongiform encephalopathies in humans and animals.

As used herein, the term “specified risk material” means tissues removed from animals slaughtered for human consumption and within which infectious agent may be present. Specified risk material includes the brain, skull, eyes, trigeminal ganglia, spinal cord, vertebral column, dorsal root ganglia, tonsils, the distal ileum of the small intestine, and combinations thereof. The National Renderers Association has defined “specified risk material” as comprising the foregoing tissues from cattle over 30 months of age, and the distal ileum and tonsils from cattle of all ages (Hamilton, C. R. and D. Kirstein, 2011).

The feedstock is preferably a waste material, such as specified risk material, which is typically disposed of in a landfill or used in a rendering plant. In one embodiment, the feedstock may be processed to reduce particle size if necessary, such as by hammer-milling, chopping, grinding or blending. A reduced particle size may facilitate the hydrolysis step which follows.

The primary scope of the first step of the process is to hydrolyze the proteins in the feedstock. As used herein, the term “hydrolyze” refers to the cleavage of amide bonds in a polypeptide to produce shorter amino acid chains with carboxylic acid functional groups and amino groups. Hydrolysis of the proteins generally results in the production of proteins and peptides with varying molecular weight, as well as free amino acids. As used herein, the term “hydrolyzed protein” is the mixture of proteins, peptides, and/or free amino acids produced by the hydrolysis of the proteins present in the feedstock. In one embodiment, hydrolysis comprises thermal hydrolysis or alkaline hydrolysis, or a combined alkaline thermal hydrolysis.

The purpose of the hydrolysis step is to produce proteins or peptides of suitable size to polymerize in a useful biocomposite material, and also to destroy or substantially mitigate any infectious agents in the feedstock material. Therefore, in embodiments where the feedstock may comprise infectious agents, more severe hydrolytic conditions may be warranted. In one embodiment, thermal hydrolysis is conducted at a temperature of about 180° C., and at a pressure of about 1,200 kPa. In one embodiment, the duration of thermal hydrolysis is at least forty minutes. Thermal hydrolysis may be conducted in a suitable thermal hydrolysis reactor which uses high pressure and saturated steam to denature organic material and destroy pathogens. Suitable reactors and their operation are well known in the art and need not be further described herein. Commercially available reactors are manufactured by Haarslev Inc., Kansas City, Mo., USA; or Dupps Company, Germantown, Ohio, USA.

In one embodiment, hydrolysis of the proteins is conducted in the presence of a base. In one embodiment, the base comprises an aqueous solution of an alkali metal hydroxide or an alkaline earth metal hydroxide. In one embodiment, the base comprises an aqueous solution of sodium hydroxide (NaOH) or potassium hydroxide (KOH). In one embodiment, the solution is used on a mass per mass basis equal or greater than about 9% of the feedstock. In one embodiment, the solution comprises about 15% sodium hydroxide (w/v) in water or about 19% potassium hydroxide (w/v) in water. In one embodiment, alkaline hydrolysis is conducted at a temperature of about 150° C., and at a pressure of at least about 400 kPa. In one embodiment, duration of alkaline hydrolysis is at least about 180 minutes per cycle.

Alkaline hydrolysis may be conducted in any enclosed pressure vessel as is known in the art. The vessel allows the immersion of the feedstock in the alkali which is then heated. The feedstock remains within the alkali until sufficiently digested to inactivate or destroy any pathogens which might be present, thereby forming a solution void of such agents. Suitable vessels are described, for example, in U.S. Pat. Nos. 7,910,788; 7,829,755; and 7,183,453; or may include, but are not limited to, the WR² alkaline hydrolysis Tissue Digestors™ manufactured by BioSAFE Engineering (Brownsburg, Ind., USA).

Without being bound to any theory, the alkali-catalyzed breaking of the peptide bonds and the addition of water at the break occurs under the above conditions, promoting rapid dissolution and hydrolysis of the proteins into small proteins, peptides and amino acids in the form of their sodium or potassium salts.

The conditions and type of hydrolysis may be chosen by one skilled in the art to produce a hydrolyzed protein having a desired degree of hydrolysis. In one embodiment, the hydrolyzed protein will have an average molecular weight of less than about 100 kDA, or 80 kDA, or 70 kDA, and preferably greater than about 1 kDA, 5 kDA, or 10 kDA. Obviously, more severe hydrolysis will produce relatively smaller peptides and more individual amino acids. Less severe hydrolysis will produce relatively larger peptides.

Proteins subjected to thermal hydrolysis without alkaline treatment will have a relatively wide range of molecular weights, with the average being below 70 kDa. Substantially all proteins subjected to alkaline thermal hydrolysis with sufficiently elevated heat and pressure are severely hydrolyzed to an average molecular weight less than about 40 kDa, and a narrower range of molecular weights. The degree of hydrolysis will increase as the concentration of water and alkaline solution per weight of the feedstock increases, respectively during hydrolysis.

After hydrolysis, a protein fraction is extracted or separated from the hydrolyzed feedstock using a combination of salts to promote the precipitation of ash or other impurities which may be detrimental to crosslinking, and selectively retain the protein fraction in aqueous solution. In one embodiment, the salt solution comprises 4% (w/v) NaCl and 0.05% (w/v) MgCl₂ in a phosphate buffer, comprising 0.067 M KH₂PO₄ and 0.067 M Na₂HPO₄, according to the method optimized by Park et al (2000) for meat and bone meal. The aqueous protein fraction comprises major active functional groups such as, for example, primary amine (—NH₂), carboxyls (—COOH), sulfhydryls (—SH), hydroxyl (—OH), and carbonyls (—CHO). The major active functional groups are positioned on the side chains of amino acids or at the amino or carboxy end of each amino acid chain. In one embodiment, the invention comprises the protein fraction obtained by the method described herein. The protein fraction may then be dried, such as by freeze-drying, and used in solid powder form.

A crosslinking reagent which reacts with the active functional groups of the protein fraction to form crosslinked polymers may then be chosen to form the polymer matrix portion of the biocomposite material. Suitable crosslinking reagents include, but are not limited to, glutaraldehyde, glyoxal, resorcinol, benzaldehyde, 1-ethyl-3-(3-dimethylaminopropyl)carbodiimide, N-hydroxysuccinimide, N,N-dicyclohexylcarbodiimide, and epoxies. In one embodiment, the crosslinking reagent comprises an epoxy. As used herein, the term “epoxy” means an epoxy resin comprising monomers or short chain polymers having functional epoxide groups. The epoxide groups react with the amine groups and other functional groups to form covalent bonds. In effect, the protein fraction is used as the curing agent for the epoxy.

One suitable epoxy comprises diglycidyl ether of bisphenol A (DGEBA), known commercially as Araldite™. DGEBA has the formula (2,2-bis[4-(2′3′ epoxy propoxy)phenyl]propane) and is derived from the reaction of bisphenol-A and epichlorohydrin. Crosslinking hydrolyzed protein fractions with DGEBA yields polymers characterized by high tensile strength and limited elongation at the breaking point. These mechanical properties are very similar to commercial epoxy-based polymers.

In one embodiment, the protein fraction and the crosslinking reagent may be blended with other polymers or substances to alter the properties of the resulting thermoset plastic. For example, it is possible to impart flexibility to DGEBA-based polymers by blending reactive natural or synthetic rubber into the DGEBA prior to curing with the hydrolyzed proteins. Carboxylic acid synthesized acrylonitrile rubbers, with carboxylic group along the chain and chain ends reacts with epoxy groups of DGEBA and polymerizes altogether through chain extension reactions, to impart flexibility of the backbone molecule. In one embodiment, 10 to 40% by weight of reactive rubber may be incorporated into epoxy resins prior to overall crosslinking with the hydrolyzed protein fraction to obtain various levels of toughness and flexibility of the resulting thermoset plastics.

Other suitable epoxies include an aliphatic polyglycol epoxy (APO) resin or resorcinol diglycidyl ether (RDE). Crosslinking hydrolyzed protein fractions with APO or RDE yields polymers with higher flexibility, lower viscosity, and reduced brittleness. Lower viscosity may improve overall processability and potentially increases the amount of proteins incorporated into the matrix.

The fibrous material may be mixed directly into the protein fraction and the cross-linking reagent, or a mixture of the protein fraction and the cross-linking reagent may be applied to a pre-formed mat of the fibrous material. The manufacture of the fibrous material and fibre performs are well known in the art, and need not be described further herein. The combination may then used as a prepreg as is known in the art, and maintained in an uncured or partially cured state. The material may be cured using any standard curing and forming technique to form the thermoset biocomposite material.

In one embodiment, adhesion between the fibrous material and the polymer matrix may be enhanced by adding surface binders or additional crosslinking agents.

The proportions of the cross-linking reagent, the protein fraction and the fiber may be varied. In one embodiment, the protein fraction comprises between about 20% to about 30% by weight of the resin/protein mixture. A larger proportion of the protein fraction may result in greater flexural strength, but at a cost of lower tensile strength.

In one embodiment, the fiber component may comprise about 10% to about 30% of the composite prior to curing, by volume, and preferably about 20%.

### EXAMPLES

The following are specific examples of embodiments and methods of making and using the present invention. These examples are offered by way of illustration and are not intended to limit the claimed invention in any manner.

### Example 1

### Preparation of Polymers and Plastics

This example demonstrates how the method of the present invention can be used in preparing a biocomposite material from animal proteins. All experiments were performed in a Biosafety Level II laboratory (University of Alberta, Edmonton, Canada) operating under a Canadian Food Inspection Agency permit for handling specified risk material.

As the starting material, the feedstock comprised specified risk material obtained from cattle. Relatively severe hydrolytic conditions were required because of the specified risk material. Thermal hydrolysis was conducted for about forty minutes per cycle at a temperature of about 180° C., and at a pressure of about 1,200 kPa using a thermal hydrolysis reactor (Parr Instruments (Moline, Ill. USA). Alkaline hydrolysis was conducted for about 180 minutes per cycle at a temperature of about 150° C., and at a pressure of about 400 kPa using a tissue digester (Parr Instruments (Moline, Ill., USA). The alkaline solution comprised about 15% sodium hydroxide (w/v) in water. In both cases, the protein fraction was then extracted from the hydrolyzed proteins using a combination of salts (4% (w/v) NaCl and 0.05% (w/v) MgCl₂ (w/v) in a phosphate buffer, comprising 0.067 M KH₂PO₄ and 0.067 M Na₂HPO₄) to precipitate ash, and to retain the protein fraction into aqueous solution. The protein fraction was then freeze-dried and stored, as a solid.

The physical, chemical and structural characteristics of the protein fraction were found to be correlated to the specific type of hydrolysis protocol.

The molecular weight analysis revealed that alkaline hydrolyzed proteins are severely cleaved to a molecular weight of less than 35 kDa due to the catalytic property of the hydroxide solution. Thermal hydrolyzed proteins have comparatively wider range of molecular weight, with an average molecular weight of less than 66 kDa.

The amino acid profile was obtained using reversed-phase HPLC. The protein fraction comprised functional groups including primary amine (—NH₂), carboxyls (—COOH), sulfhydryls (—SH), hydroxyl (—OH), and carbonyls (—CHO). The functional groups were positioned on the side chain of each amino acid or the end of each main chain.

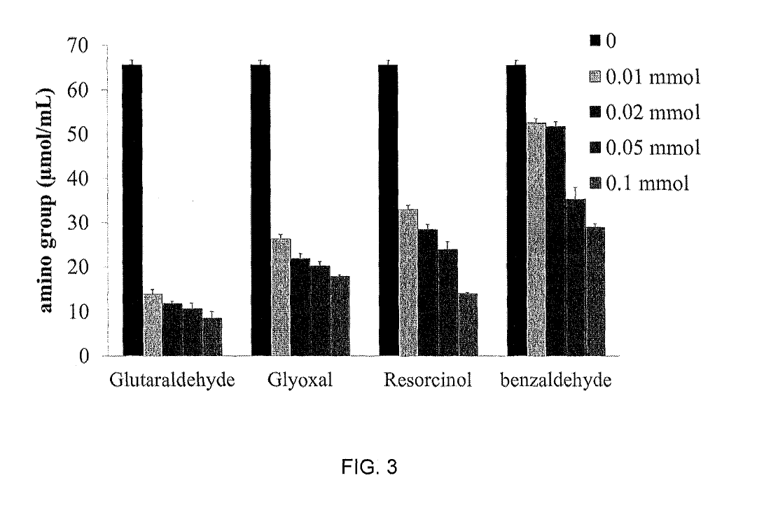

Both thermal and alkaline hydrolysis yielded protein fractions which are amenable to crosslinking, providing two distinct routes to prepare final products having different properties. A functional group study showed that most functional groups of protein survived the conditions of both thermal and alkaline hydrolysis. The reduction in functional groups was used to measure the level of crosslinking of proteins with various agents (i.e., glutaraldehyde, glyoxal, resorcinol, and benzaldehyde) at various molar concentrations (i.e., 0 mmol, 0.01 mmol, 0.02 mmol, 0.05 mmol, and 0.1 mmol). A linear reduction of amine group was observed as the molar concentration of each of the crosslinking reagents was increased (FIG. 3).

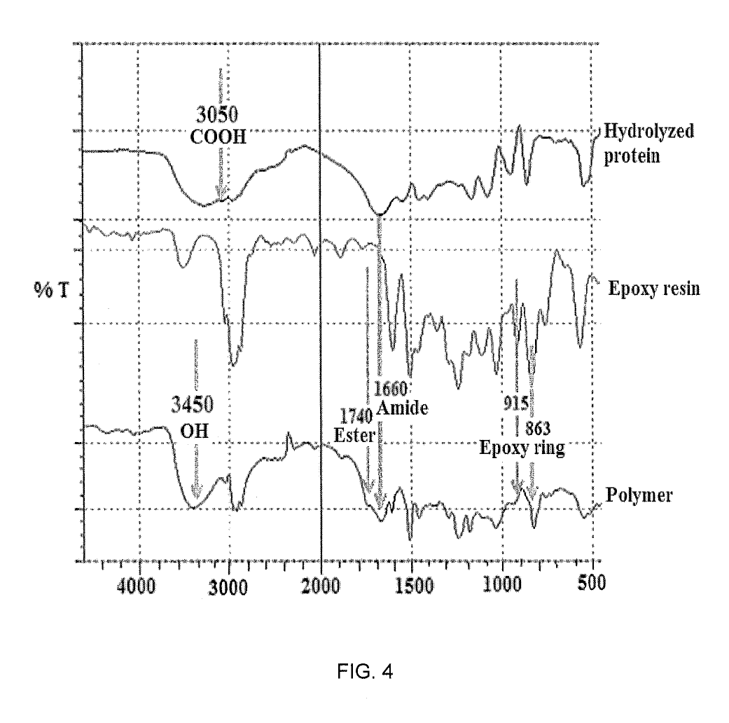

FIG. 4 is a Fourier transform infrared spectra of hydrolyzed protein, epoxy resin, and epoxy resin crosslinked polymer. The spectra showed carboxylic acid and epoxy ring reduction and the formation of new ester bonds. Epoxy, being reactive to several of protein functional groups, exhibited superior crosslinking property.

### Example 2

### Use of RDE as Crosslinking Reagent

This example demonstrates how the method of the present invention can use resorcinol diglycidyl ether (RDE) as a crosslinking reagent.

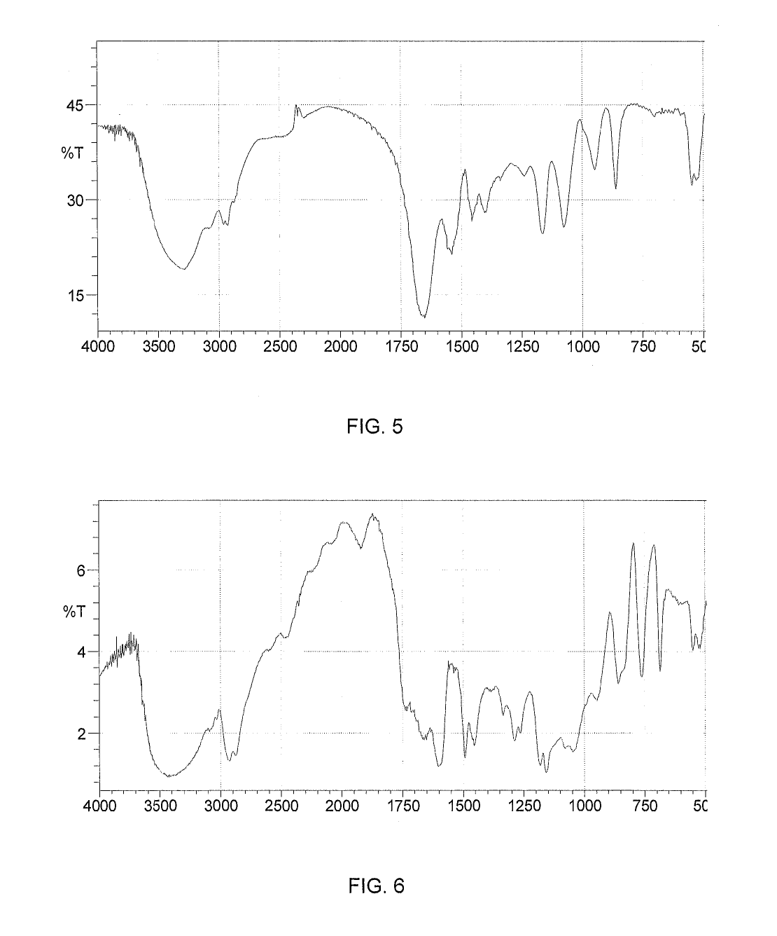

FIG. 5 is a Fourier transform infrared spectra of hydrolyzed protein prior to crosslinking. FIG. 6 is a Fourier transform infrared spectra of the hydrolyzed protein of FIG. 5 after crosslinking with RDE. The broad absorption band in the range of 3200-3500 cm⁻¹ corresponds to the hydroxyl (O—H) of the hydrolyzed proteins whereas the band at around 1525 cm⁻¹ can be attributed to the amine group (N—H) of the protein chain. A comparison of FIGS. 5 and 6 depicts how both groups have disappeared following crosslinking, demonstrating that epoxy can cap both reactive moieties.

### Example 3

### Method of Preparing Biocomposites

Twelve combinations of Araldite™ epoxy resin with 4-aminophenyl sulfone (4-APS) and with the solid, freeze-dried protein fraction produced by thermal hydrolysis as described above were produced. Three types of the fibre mats—50 mm E-glass chopped strand mat (CSM), 6.0 oz E-glass woven roving (WR) mat, and 50 mm random hemp mats obtained by a wet laid technique (HE)—were used as the fibrous component for the epoxy composites. Table 1 lists the combinations of the epoxy resin, curing agent, and the fibre mats.

TABLE 1

| | | | | Curing | | | |
|---|---|---|---|---|---|---|---|
| | | | | agent | Epoxy | Fibre | Resin |
| No. | Label | Plate Type | Curing | (wt. %) | (wt. %) | (vol. %) | (vol. %) |
| 1 | APS20 | Resin | 4-APS | 20 | 80 | 0.0 | 100.0 |
| 2 | P20 | Resin Only | Protein | 20 | 80 | 0.0 | 100.0 |
| 3 | P30 | Resin Only | Protein | 30 | 70 | 0.0 | 100.0 |
| 4 | APS2OCSM | Glass CSM Composite | 4-APS | 20 | 80 | 20.0 | 80.0 |
| 5 | P2OCSM | Glass CSM Composite | protein | 20 | 80 | 20.0 | 80.0 |
| 6 | P3OCSM | Glass CSM Composite | protein | 30 | 70 | 20.0 | 80.0 |
| 7 | APS20WR | Glass WR Composite | 4-APS | 20 | 80 | 20.0 | 80.0 |
| 8 | P2OWR | Glass WR Composite | protein | 20 | 80 | 20.0 | 80.0 |
| 9 | P3OWR | Glass WR Composite | protein | 30 | 70 | 20.0 | 80.0 |
| 10 | APS2OHE | Hemp Mat Composite | 4-APS | 20 | 80 | 20.0 | 80.0 |
| 11 | P2OHE | Hemp Mat Composite | protein | 20 | 80 | 20.0 | 80.0 |
| 12 | P3OHE | Hemp Mat Composite | protein | 30 | 70 | 20.0 | 80.0 |

The unreinforced plates (without a fibrous component) were prepared as follows. Pre-weighed amounts of the epoxy resin and the curing agent were mixed and degassed at 100° C. for one hour in a vacuum oven. The mixture was then cured at 185° C. for four hours, with additional curing at 180° C. for 1 hour. Overall amounts of the epoxy resin, curing agent, and the fibre mats were calculated based on the mold volume and the materials' densities.

The resin was cured inside the silicone baking trays (22.5 cm×22.5 cm). A PTFE sheet was placed on the bottom of the tray to prevent the resin from sticking to the silicone surface. Some stress cracking was noted during cooling. Overall, nine unreinforced 22.5 cm×22.5 cm×3 mm plates were obtained by this technique: three plates with 20% 4-APS, three plates with 20% protein, and three plates with 30% protein as a curing agent.

Preparation of the fibre-reinforced plates was produced with a slight variation of this technique. Precut fibre mats were used as the reinforcement. The quantity of the resin/curing agent was calculated based on the overall weight of the fibre and the fibre density.

A PTFE sheet was placed at the bottom of the silicone tray and a small amount of mixed curing agent and resin was poured onto the PTFE sheet and spread out with hand rollers. A fibre mat was put on top of the resin and the rolled with the hand rollers to allow the resin to soak in and more resin was poured on top of the mat and distributed evenly with the hand rollers. Additional layers of fibre mats were added following the same procedure: alternating the fibre and the resin layers and squeezing the resin into the fibre with the hand rollers. Finally, another PTFE sheet was placed on top of the composite sandwich. The number of fibre mat layers varied with the type of the fibre: 3 layers of CSM, 8 layers of WR, and 2 layers of HE fibre. The composite sandwiches were degassed as normal and then flipped over from the tray onto a large PTFE sheet.

To achieve 20% fibre volume fraction, the thickness of the plates had to be controlled by using 3 mm shims and applying pressure to the plates. Pressure was required to overcome natural springiness of the fibres as well as to squeeze the air bubbles trapped in between the fibre layers even after degassing.

Large PTFE sheets with the uncured resin/fibre sandwich were transferred into the French press. Each composite was cured in the press at 7 ton clamping pressure and 185° C. for two hours. Although the 4-APS-based plates cured after just two hours inside the press, the protein-based composites required some additional curing time. Additional post-curing was done in the convection oven at 185° C. for another two hours. Any uncured resin was washed of the plates with toluene, and the plates were allowed to dry/cure in the oven at 200° C. for another two hours.

Any residual uncured resin from the surface or the edge were cleaned with toluene. Overall, twenty seven 22 cm×22 cm×3 mm plates were obtained by this technique: three per each reinforced sample (samples No. 4-12, see Table 1).

### Example 4

### Biocomposite Testing

Water jet cutting procedure was used to cut out the test specimens, however, water jet cutting procedure turned out to be unsuitable for cutting the specimens out of the unreinforced plates. The plates, being too brittle, cracked and chipped. As a result, no test coupons from these unreinforced plates could be obtained.

Both tensile and flexural bars were cut out of the fibre reinforced plates. Overall, 16 tensile bars and 12 flexural bars were obtained per sample. Half of these specimens were used in the dry tests, and another half was used in the wet tests.

The mechanical tests were performed according to the ASTM D638-08 (Standard Test Method for Tensile Properties of Plastics) and ASTM D790-07 (Standard Test Methods for Flexural Properties of Unreinforced and Reinforced Plastics and Electrical Insulating Materials). Two variations of the tests were performed: dry and wet. For dry variation, the specimens were conditioned at 23° C. and 50% relative humidity for 48 hours and tested according to the ASTM procedures. Wet variation involved conditioning the specimens in the reverse osmosis (RO) water for 30 days prior to conducting the tests. The water in the tank had to be replaced regularly due to changing of the water colour.

Table 2 and Table 3 show the results of the mechanical tests of the dry specimens.

TABLE 2
Tensile properties of the dry epoxy composites

| | | | Maximum | | | | | |
|---|---|---|---|---|---|---|---|---|
| | | Number of the | Tensile | | Tensile | | Elongation | |
| | | specimens included | strength | St. Dev. | Modulus | St. Dev. | at Break | St. Dev. |
| No. | Label | in the data | (MPa) | (MPa) | (GPa) | (GPa) | (%) | (%) |
| 4 | APS2OCSM | 5/7 | 142.35 | 12.93 | 11.52 | 0.83 | 1.55 | 0.19 |
| 5 | P2OCSM | 3/7 | 102.37 | 24.42 | 8.80 | 0.84 | 1.55 | 0.27 |
| 6 | P3OCSM | 5/8 | 97.32 | 12.58 | 9.01 | 0.36 | 1.45 | 0.21 |
| 7 | APS20WR | 7/8 | 168.69 | 31.26 | 16.38 | 1.85 | 1.38 | 0.10 |
| 8 | P2OWR | 8/8 | 108.95 | 27.29 | 10.25 | 2.71 | 1.35 | 0.21 |
| 9 | P3OWR | 5/5 | 76.59 | 11.72 | 7.45 | 0.70 | 1.56 | 0.14 |
| 10 | APS2OHE | 5/6 | 27.55 | 3.05 | 4.88 | 0.58 | 0.78 | 0.14 |
| 11 | P2OHE | 4/9 | 14.14 | 3.65 | 3.93 | 0.59 | 0.63 | 0.25 |
| 12 | P3OHE | 4/8 | 11.94 | 2.45 | 4.05 | 0.53 | 0.41 | 0.14 |

TABLE 3
Flexural properties of the dry epoxy composites

| | | | Maximum | | | | | |
|---|---|---|---|---|---|---|---|---|
| | | Number of the | Flexural | | Flexural | | Strain at | |
| | | specimens included | strength | St. Dev. | Modulus | St. Dev. | First Break | St. Dev. |
| No. | Label | in the data | (MPa) | (MPa) | (GPa) | (GPa) | (00) | (%) |
| 4 | APS2OCSM | 5/5 | 188.88 | 12.67 | 8.25 | 1.03 | 2.56 | 0.32 |
| 5 | P2OCSM | 5/5 | 152.63 | 18.00 | 6.77 | 0.57 | 2.48 | 0.25 |
| 6 | P3OCSM | 5/5 | 180.27 | 23.89 | 7.05 | 0.69 | 2.68 | 0.32 |
| 7 | APS20WR | 5/5 | 207.55 | 93.76 | 14.88 | 3.25 | 1.39 | 0.40 |
| 8 | P20WR | 4/5 | 44.47 | 13.75 | 2.71 | 1.03 | 1.94 | 0.32 |
| 9 | P3OWR | 5/5 | 38.91 | 6.07 | 4.36 | 0.30 | 0.96 | 0.21 |
| 10 | APS2OHE | 5/5 | 60.75 | 3.82 | 4.16 | 0.49 | 2.09 | 0.25 |
| 11 | P2OHE | 5/5 | 32.45 | 3.50 | 3.78 | 0.27 | 1.03 | 0.13 |
| 12 | P3OHE | 5/5 | 34.46 | 10.38 | 4.27 | 0.53 | 1.01 | 0.25 |

It can be seen from the tables that some of the data sets exhibited rather large standard deviations. Several factors were considered to contribute to these large deviations from the mean. Low number tested specimens; during tensile tests, many specimens broke outside of the mid-section. The recorded data from these specimens had to be excluded from the calculation of the mean and standard deviation according to ASTM D638-08 requirements. In some cases, the results of the tests were based on just four specimens. The sample surface was not uniform due to the presence of the gas bubbles. Despite preliminary degassing under vacuum it was impossible to completely eliminate the bubbles due to epoxy resin constantly degassing at high temperatures. Therefore, the actual sample thickness varied and could not be measured precisely. Some specimens exhibited fibre layer delamination during the tests. Such delamination caused large variability in the specimens. Fibre distribution was another issue. In the case of random fibre mats, such distribution cannot be precisely controlled

Table 4 and Table 5 show the results of the mechanical tests of the wet specimens. Table 6 and Table 7 show the weight gain of the tensile and flexural bars after 30 days in water. When measuring the mechanical properties, the same problems were encountered as in the case of the dry specimens: non-uniform sample surface, fibre layer delamination, and uneven fibre distribution. Some damp or soggy specimens were not tested.

TABLE 4
Tensile properties of the wet epoxy composites

| | | | Maximum | | | | | |
|---|---|---|---|---|---|---|---|---|
| | | Number of the | Tensile | | Tensile | | Elongation | |
| | | specimens included | strength | St. Dev. | Modulus | St. Dev. | at Break | St. Dev. |
| No. | Label | in the data | (MPa) | (MPa) | (GPa) | (GPa) | (%) | (%) |
| 4 | APS2OCSM | 5/8 | 135.06 | 18.90 | 11.87 | 1.98 | 1.52 | 0.18 |
| 5 | P2OCSM | 5/6 | 52.68 | 5.57 | 7.50 | 0.76 | 0.80 | 0.05 |
| 6 | P3OCSM | 5/7 | 53.14 | 2.83 | 6.67 | 0.41 | 0.94 | 0.07 |
| 7 | APS20WR | 5/8 | 178.48 | 52.56 | 16.48 | 0.64 | 1.42 | 0.35 |
| 8 | P2OWR | 5/8 | 42.41 | 3.14 | 3.63 | 0.68 | 1.17 | 0.21 |
| 9 | P3OWR | 4/8 | 40.55 | 1.44 | 4.89 | 0.14 | 1.04 | 0.05 |
| 10 | APS2OHE | 5/8 | 19.91 | 1.48 | 2.65 | 0.48 | 1.10 | 0.32 |
| 11 | P2OHE | 3/4 | 10.25 | 0.85 | 1.69 | 0.24 | 0.89 | 0.20 |
| 12 | P3OHE | 5/8 | 4.72 | 1.69 | 0.74 | 0.15 | 1.08 | 0.48 |

TABLE 5
Flexural properties of the wet epoxy composites

| | | Number of the | Maximum | | St. Dev. | | Strain | |
|---|---|---|---|---|---|---|---|---|
| | | specimens | Flexural | | Flexural | | at | |
| | | included | strength | | Modulus | St. Dev. | First Break | St. Dev. |
| No. | Label | in the data | (MPa) | (MPa) | (GPa) | (GPa) | eY0) | 00) |
| 4 | APS2OCSM | 5/5 | 186.68 | 13.31 | 8.08 | 0.77 | 2.59 | 0.18 |
| 5 | P2OCSM | 5/5 | 79.22 | 7.44 | 5.51 | 0.60 | 1.52 | 0.12 |
| 6 | P30CSM | 5/5 | 74.93 | 13.94 | 4.25 | 0.63 | 1.84 | 0.11 |
| 7 | APS20WR | 5/5 | 238.71 | 33.96 | 14.92 | 0.66 | 1.68 | 0.12 |
| 8 | P2OWR | 3/6 | 21.84 | 7.64 | 0.77 | 0.29 | 3.20 | 0.85 |
| 9 | P3OWR | 5/5 | 15.20 | 3.97 | 0.79 | 0.21 | 3.63 | 1.22 |
| 10 | APS2OHE | 5/5 | 47.44 | 8.46 | 2.24 | 0.41 | 4.05 | 0.51 |
| 11 | P2OHE | 5/5 | 12.25 | 2.09 | 0.67 | 0.10 | 3.26 | 0.35 |
| 12 | P3OHE | 4/5 | 4.96 | 1.88 | 0.26 | 0.09 | 4.08 | 0.73 |

TABLE 6
Water absorption of the tensile bars after 30 days in water

| | | Number of the specimens | Weight | St. |
|---|---|---|---|---|
| No. | Label | included in the data | Gain (%) | Dev. (%) |
| 4 | APS2OCSM | 8/8 | 0.87 | 0.22 |
| 5 | P2OCSM | 8/8 | 13.32 | 2.01 |
| 6 | P3OCSM | 8/8 | 13.35 | 3.10 |
| 7 | APS20WR | 8/8 | 0.698 | 0.13 |
| 8 | P2OWR | 8/8 | 30.23 | 15.34 |
| 9 | P3OWR | 8/8 | 34.81 | 4.43 |
| 10 | APS2OHE | 8/8 | 17.63 | 2.05 |
| 11 | P2OHE | 3/8 (specimens | 31.35 | 0.11 |
| | | were very wet) | | |
| 12 | P3OHE | 8/8 | 38.94 | 5.16 |

TABLE 7
Water absorption of the flexural bars after 30 days in water

| | | Number of the specimens | Weight | St. |
|---|---|---|---|---|
| No. | Label | included in the data | Gain (%) | Dev. (%) |
| 4 | APS2OCSM | 6/6 | 1.34 | 0.24 |
| 5 | P2OCSM | 6/6 | 13.23 | 0.6 |
| 6 | P3OCSM | 6/6 | 12.49 | 0.67 |
| 7 | APS20WR | 6/6 | 0.5 | 0.04 |
| 8 | P2OWR | 6/6 | 31.15 | 2.63 |
| 9 | P3OWR | 6/6 | 36.51 | 1.23 |
| 10 | APS2OHE | 6/6 | 14.45 | 2.91 |
| 11 | P2OHE | 6/6 | 23.46 | 2.62 |
| 12 | P3OHE | 6/6 | 38.37 | 4.01 |

Thermogravimetric analysis (TGA) was done, in duplicate, according to ASTM2550-11 (Standard Test Method for Thermal Stability by Thermogravimetry) with TA Instruments Q600 analyzer. Measurements were conducted in the range from room temperature up to 450° C. at the heating rate of 5° C./min. Nitrogen flow of 100 mL/min was used to prevent sample oxidation. Table 10 summarizes the results of the TGA analysis. Note that the initial weight loss for some specimens due to moisture evaporation is not reflected in the Table 8.

TABLE 8
Results of TGA Analysis

| | Transition Temperature 1 (° C.) | | | Transition Temperature 2 (° C.) | | |
|---|---|---|---|---|---|---|
| Label | Specimen 1 | Specimen 2 | Average | Specimen 1 | Specimen 2 | Average |
| APS20 | 362.69 | 363.62 | 363.16 | | | Not observed |
| P20 | 332.30 | 336.71 | 334.51 | | | Not observed |
| P30 | 357.42 | 353.20 | 355.31 | | | Not observed |
| APS2OCSM | 368.58 | 370.25 | 369.42 | | | Not observed |
| P2OCSM | 352.63 | 354.09 | 353.36 | | | Not observed |
| P3OCSM | 327.93 | 307.28 | 317.61 | | | Not observed |
| APS20WR | 368.73 | 371.31 | 370.02 | | | Not observed |
| P2OWR | 365.65 | 36142 | 364.04 | | | Not observed |
| P3OWR | 338.43 | 333.81 | 336.12 | | | Not observed |
| APS2OHE | 320.43 | 321.63 | 321.03 | 384.21 | 384.13 | 384.17 |
| P2OHE | 301.08 | 296.03 | 298.56 | 378.75 | 373.72 | 376.24 |
| P3OHE | 297.41 | 297.43 | 297.42 | 375.1 | 373.46 | 374.28 |

### REFERENCES

The following references are incorporated herein by reference (where permitted) as if reproduced in their entirety. All references are indicative of the level of skill of those skilled in the art to which this invention pertains.
ASTM D2339-98, Standard Test Method for Strength Properties of Adhesives in Two-Ply Wood Construction in Shear by Tension Loading ASTM, West Conshohocken, 15 Jun. 2002.
CFIA. 2009 Bovine Spongiform Encephalopathy Manual of Procedures. (accessed Sep. 9, 2010).
Hamilton, C. R. and D. Kirstein. 2011, National Renderers Association
Wilson, J. H.; Kaye; G. I.; Hahn, R. L.; Weber, P. B, and Morris, K. A. System for treating infectious waste matter. U.S. Pat. No. 7,910,788, issued Mar. 22, 2011.
Wilson, J. H.; Kaye, G. I.; Hahn, R. L.; Weber, P. B. and Morris, K. A. System and method for treating infectious waste matter. U.S. Pat. No. 7,829,755, issued Nov. 9, 2010.
Wilson, J. H.; Kaye, G. I.; Hahn, R. L.; Weber, P. B. and Morris, K. A. Method for treating infectious waste matter. U.S. Pat. No. 7,183,453, issued Feb. 27, 2007.
Park, S. K., Bae, D. H., Hettiarachchy, N. S. 2000. Protein Concentrate and adhesives from meat and bone meal. JAOCS. 77(11), 1223-1227.

What is claimed is:

1. A method for preparing a biocomposite material from a feedstock comprising animal proteins, comprising the steps of:
a) hydrolyzing the feedstock and recovering a protein fraction;
b) combining a fibrous material with the protein fraction and a crosslinking reagent to form a prepolymer or a prepreg; and
c) curing the mixture to create a thermoset composite material.

2. The method of claim 1 wherein the feedstock comprises a waste animal material.

3. The method of claim 2 wherein the feedstock comprises specified risk material.

4. The method of claim 3 wherein the feedstock is hydrolyzed to destroy or mitigate any infectious agents present in the feedstock.

5. The method of claim 3 wherein the feedstock is hydrolyzed to produce proteins in the size range of about 1 kDA to about 100 kDa.

6. The method of claim 5 wherein the proteins are less than about 70 kDa.

7. The method of claim 6 wherein the proteins are less than about 35 kDa.

8. The method of claim 1 wherein the fibrous material comprises a synthetic fiber or a natural fiber.

9. The method of claim 8 wherein the fibrous material comprises glass fiber or hemp fiber.

10. The method of claim 1 wherein the hydrolysis step comprises thermal or alkaline hydrolysis.

11. The method of claim 1 wherein the protein fraction is recovered by salt precipitation of non-protein components from the hydrolysate, and retaining the protein fraction in aqueous solution.

12. The method of claim 1 wherein the protein fraction comprises between about 20% to about 30% by weight of the cured material.

13. The method of claim 1 wherein the crosslinking reagent comprises glutaraldehyde, glyoxal, resorcinol, benzaldehyde, 1-ethyl-3-(3-dimethylaminopropyl)carbodiimide, N-hydroxysuccinimide, N,N-dicyclohexylcarbodiimide, or an epoxy.

14. The method of claim 13 wherein the cross-linking reagent comprises diglycidyl ether of bisphenol A.

15. A biocomposite material or prepreg comprising a fiber reinforced polymer comprising an animal protein crosslinked with a crosslinking reagent.

16. The biocomposite material or prepreg of claim 15 wherein the animal protein comprises a protein fraction recovered from hydrolyzed specified risk material.

17. The biocomposite material or prepreg of claim 15 wherein the fiber comprises a synthetic fiber or a natural fiber.

18. The biocomposite material or prepreg of claim 17 wherein the fiber comprises a pre-woven mat of glass fiber or hemp fiber.
